(19) United States
(12) Patent Application Publication
(10) Pub. No.: US 2022/0291407 A1
(43) Pub. Date: Sep. 15, 2022

(54) METHOD AND DEVICE FOR ELASTIC PARAMETER INVERSION

(71) Applicant: INSTITUTE OF GEOLOGY AND GEOPHYSICS, CHINESE ACADEMY OF SCIENCES, Beijing (CN)

(72) Inventors: Anqi Zou, Beijing (CN); Yanfei Wang, Beijing (CN)

(21) Appl. No.: 17/669,658

(22) Filed: Feb. 11, 2022

(30) Foreign Application Priority Data
Dec. 11, 2020 (CN) CN 202011462534.8

(51) Int. Cl. G01V 1/30; G01V 1/28

(52) U.S. Cl. CPC G01V 1/306; G01V 1/282; G01V 2210/6242

(57) ABSTRACT

The present disclosure provides a method and a device for elastic parameter inversion, relating to the technical field of seismic inversion, including: firstly, acquiring a multichannel non-stationary seismogram; then, determining elastic impedance corresponding to the multichannel non-stationary seismogram according to an established first association relationship model; and finally, determining an elastic parameter corresponding to the elastic impedance according to an established second association relationship model.

### CROSS-REFERENCE TO RELATED APPLICATION

The present disclosure claims priority of Chinese patent application with the filing number CN 2020114625348 filed on Dec. 11, 2020 with the Chinese Patent Office, and entitled “Method and Device for Elastic Parameter Inversion”, the contents of which are incorporated herein by reference in entirety. The entire delay between the filing of the application claiming benefit of the prior Chinese patent application and the expiration date of the 12 month period for filing the application claiming benefit of the prior Chinese patent application under 37 CFR 1.78 and 1.55 was unintentional.

### TECHNICAL FIELD

The present disclosure relates to the technical field of seismic inversion, and particularly to a method and a device for elastic parameter inversion.

### BACKGROUND ART

When describing petrophysical characteristics of the reservoir, a proper understanding of elastic parameters is required, while the elastic parameters can be obtained in the prior art through inversion from pre-stack seismic data by utilizing the concept of elastic impedance (EI). The elastic impedance is a generalization of acoustic impedance (AI) having a variable incidence angle, and it provides a framework for obtaining elastic parameters through calibration and inversion of nonzero-offset seismic data. Existing inversion technologies include AVO (Amplitude variation with offset) inversion, regularization inversion and the like, but these methods are not suitable for elastic impedance inversion and elastic parameter inversion of multichannel non-stationary seismograms.

### SUMMARY

An object of the present disclosure is to provide a method and a device for elastic parameter inversion, so as to alleviate the technical problem existing in the prior art of non-suitability for elastic impedance inversion and elastic parameter inversion of multichannel non-stationary seismograms.

In a first aspect, the present disclosure provides a method for elastic parameter inversion, comprising steps of: acquiring a multichannel non-stationary seismogram; determining elastic impedance corresponding to the multichannel non-stationary seismogram according to an established first association relationship model; and determining an elastic parameter corresponding to the elastic impedance according to an established second association relationship model, wherein the first association relationship model and the second association relationship model constitute a multichannel non-stationary seismic model.

Further, the step of determining elastic impedance corresponding to the multichannel non-stationary seismogram according to an established first association relationship model comprises: converting the ill-posed problem of solving the elastic impedance into an optimization problem with constraints according to the first association relationship model; and solving the optimization problem according to the multichannel non-stationary seismogram and an objective optimization method so as to obtain the elastic impedance.

Further, the objective optimization method comprises Split-Bregman iterative method, and the step of solving the optimization problem according to the multichannel non-stationary seismogram and an objective optimization method so as to obtain the elastic impedance comprises: determining an initialization parameter; and solving the optimization problem by utilizing the Split-Bregman iterative method on the basis of the initialization parameter and the multichannel non-stationary seismogram, so as to obtain the elastic impedance.

Further, the step of determining an elastic parameter corresponding to the elastic impedance according to an established second association relationship model comprises: determining an expression form of the second association relationship model, wherein the expression form comprises a discrete matrix form; and obtaining the elastic parameter through the solution by means of the least square method according to the elastic impedance and the second association relationship model in the discrete matrix form, wherein the second association relationship model represents the corresponding association between the elastic impedance and the elastic parameter in a form of a discrete matrix.

Further, the multichannel non-stationary seismogram is a collection of convolutions of multichannel non-stationary seismic wavelets under different incidence angles and stratum reflection coefficients.

Further, the elastic parameter comprises one or more of the following parameters: P-wave velocity, S-wave velocity, and density.

In a second aspect, the present disclosure provides a device for elastic parameter inversion, comprising: an acquisition unit, configured to acquire a multichannel non-stationary seismogram; a first determining unit, configured to determine elastic impedance corresponding to the multichannel non-stationary seismogram according to an established first association relationship model; and a second determining unit, configured to determine an elastic parameter corresponding to the elastic impedance according to an established second association relationship model, wherein the first association relationship model and the second association relationship model constitute a multichannel non-stationary seismic model.

Further, the first determining unit includes: a conversion module, which converts the ill-posed problem of solving the elastic impedance into an optimization problem with constraints according to the first association relationship model; and a first solving module, which solves the optimization problem according to the multichannel non-stationary seismogram and an objective optimization method so as to obtain the elastic impedance.

In a third aspect, the present disclosure further provides an electronic apparatus, comprising a memory and a processor, wherein the memory stores computer programs runnable in the processor, wherein the method for elastic parameter inversion is implemented, when the processor executes the computer program.

In a fourth aspect, the present disclosure further provides a computer-readable medium having nonvolatile program codes which could be executed by a processor, wherein the program codes enable the processor to execute the method for elastic parameter inversion.

The method and the device for elastic parameter inversion provided in the present disclosure comprise: firstly, acquiring a multichannel non-stationary seismogram; then, determining elastic impedance corresponding to the multichannel non-stationary seismogram according to an established first association relationship model; and finally, determining an elastic parameter corresponding to the elastic impedance according to an established second association relationship model. In the present disclosure, on the basis of the two association relationship models, the elastic impedance can be determined according to the multichannel non-stationary seismogram, and the elastic parameter can be determined accordingly, which is suitable for elastic impedance inversion and elastic parameter inversion of multichannel non-stationary seismograms.

### BRIEF DESCRIPTION OF DRAWINGS

In order to more clearly describe the technical solutions of the embodiments of the present disclosure or in the prior art, the figures required to be used in the description of the embodiments or the prior art will be simply presented below. Apparently, the figures described below show some embodiments of the present disclosure, and for a person ordinarily skilled in the art, other figures could be obtained according to these figures without using any inventive efforts.

FIG. 1 shows a flow chart of a method for elastic parameter inversion provided in an embodiment of the present disclosure;

FIG. 2 shows a flow chart of Step S102 in FIG. 1;

FIG. 3 shows a flow chart of Step S201 in FIG. 2; and

FIG. 4 shows a structural schematic view of a device for elastic parameter inversion provided in an embodiment of the present disclosure.

### REFERENCE SIGNS

11—acquisition unit; 12—first determining unit; and 13—second determining unit.

### DETAILED DESCRIPTION OF EMBODIMENTS

The technical solutions of the present disclosure will be clearly and comprehensively described below with reference to the embodiments, and apparently, the described embodiments are partial embodiments of the present disclosure, but not all the embodiments. All other embodiments, which could be obtained by a person ordinarily skilled in the art based on the embodiments in the present disclosure without inventive effort, shall fall within the scope of protection of the present disclosure.

In order to describe petrophysical characteristics of the reservoir, a proper understanding of elastic parameters such as P-wave velocity, S-wave velocity (i.e., Vp, Vs), and density (φ is required, and these parameters can be obtained through inversion from pre-stack seismic data by utilizing the concept “elastic impedance (EI)”. The concept “elastic impedance (EI)” was firstly proposed by Connolly (1999). EI refers to a generalization of acoustic impedance having a variable incidence angle, and it provides a framework for obtaining elastic parameters through calibration and inversion of nonzero-offset seismic data, which is similar to the processing procedure of acoustic impedance inversion from zero-offset seismic data (Connolly, 1999). The concept EI helps more general petrophysical studies and prediction of reservoir physical properties, such as the porosity, the saturability, and the permeability or the like, in the seismic reservoir description. The prior art includes AVO inversion, regularization inversion and the like, but these inversion methods are not suitable for elastic impedance inversion and elastic parameter inversion of multichannel non-stationary seismograms. On this basis, an object of the present disclosure lies in providing a method and a device for elastic parameter inversion, wherein the multichannel non-stationary seismic model is improved and can be suitable for elastic impedance inversion and elastic parameter inversion of multichannel non-stationary seismograms.

To facilitate the understanding of the present embodiment, a method for elastic parameter inversion disclosed in the embodiments of the present disclosure is firstly described in detail.

### Example 1

According to the embodiment of the present disclosure, an example of the method for elastic parameter inversion is provided. It shall be clarified that steps shown in the flow charts in the accompanying drawings could be executed in a computer system of e.g., a set of computer-executable instructions, and although a logical order is shown in the flow charts, the steps shown or described may be executed under certain circumstances in an order differing from that shown here.

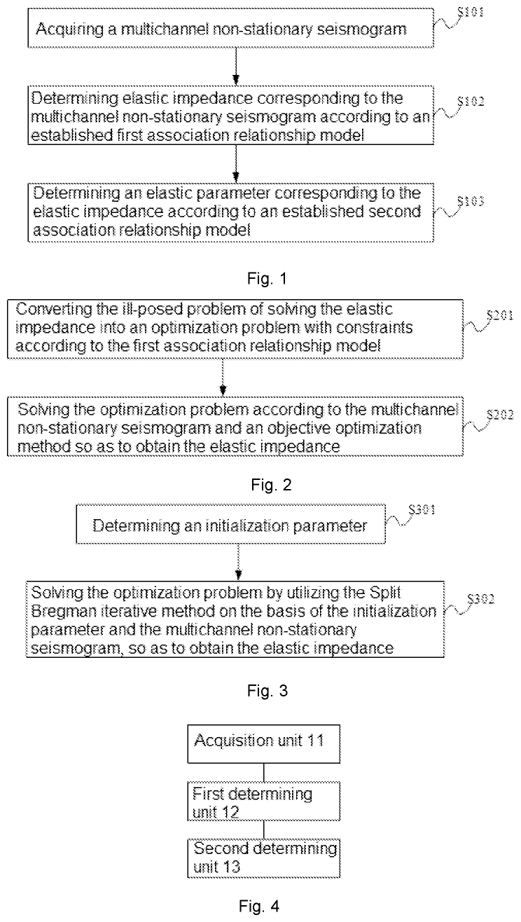

FIG. 1 is a flow chart of a method for elastic parameter inversion provided in an embodiment of the present disclosure, and as shown in FIG. 1, this method comprises following steps:

Step S101 of acquiring a multichannel non-stationary seismogram. The multichannel non-stationary seismogram is a collection of convolutions of non-stationary seismic wavelets under different incidence angles and stratum reflection coefficients.

Step S102 of determining elastic impedance corresponding to the multichannel non-stationary seismogram according to an established first association relationship model. The first association relationship model is a part of the multichannel non-stationary seismic model to be constructed in the present disclosure. The establishment of the first association relationship model can assure the precision of elastic impedance inversion.

In the present embodiment, the first association relationship model can be obtained according to the definition of the elastic impedance and a multichannel non-stationary stratigraphic model, and this first association relationship model is configured to represent the relationship between the multichannel non-stationary seismogram and the elastic impedance as follows:

S_{θ}=WₐDₜZ_{θ}+N_{θ}

where S_{θ} represents a known two-dimensional seismic section, θ represents an incidence angle, N_{θ} represents stochastic noise, and Wₐ represents the matrix form of non-stationary seismic wavelet under the incidence angle

$$\frac{1}{2 π} {\int }_{- ∞}^{+ ∞}$$

W(f)α(τ,f)e^{2πif(t-τ)}df, where W(f) is the Fourier transform of the non-stationary seismic wavelet,

$$α ( τ , f ) = {e}^{- π f {\int }_{0}^{t} \frac{1}{Q ( τ )} d τ}$$

is the non-stationary attenuation effect of the stratum, f represents a frequency variable, and t and τ both represent time variables. It should be noted that S_{θ} also can represent a known seismic section of other dimensions, but since the present embodiment is proposed mainly for the inversion of two-dimensional multichannel non-stationary seismograms, it is marked here as a two-dimensional seismic section. Dₜ is a difference matrix and represents a difference operator in the longitudinal time dimension of the multichannel non-stationary seismogram, that is:

$${D}_{t} = \frac{1}{2} [ \begin{matrix}- 1 & 1 & & & \\ & - 1 & 1 & & \\ & & ⋱ & ⋱ & \\ & & & - 1 & 1\end{matrix} ]$$

$${Z}_{θ} = \frac{1}{2} ln ( {EI}_{θ} ) ,$$

where EI_{θ} is the elastic impedance to be solved.

Step S103 of determining an elastic parameter corresponding to the elastic impedance according to an established second association relationship model. The first association relationship model and the second association relationship model constitute a multichannel non-stationary seismic model. The elastic parameter comprises one or more of the following parameters: P-wave velocity, S-wave velocity, and density.

The established second association relationship model represents the relationship between the elastic impedance and the elastic parameter:

log(EI_{θ})=(1+tan²(θ))log(Vₚ)−8K sin²(θ)log(Vₛ)+(1−4K sin²(θ))log(ρ)

where Vₚ is the P-wave velocity in the elastic parameters, Vₛ is the S-wave velocity in the elastic parameters, and ρ is the density in the elastic parameters.

In the method for elastic parameter inversion provided in the embodiment of the present disclosure, a multichannel non-stationary seismogram is firstly acquired; elastic impedance corresponding to the multichannel non-stationary seismogram is then determined according to the established first association relationship model; and an elastic parameter corresponding to the elastic impedance is finally determined according to the established second association relationship model. In the embodiment of the present disclosure, on the basis of the two association relationship models, the elastic impedance can be determined according to the multichannel non-stationary seismogram, and the elastic parameter can be determined accordingly, which is suitable for elastic impedance inversion and elastic parameter inversion of multichannel non-stationary seismograms.

In an optional embodiment, as shown in FIG. 2, the step S102 of determining elastic impedance corresponding to the multichannel non-stationary seismogram according to an established first association relationship model comprises the following step S201 and step S202, wherein:

Step S201 of converting the ill-posed problem of solving the elastic impedance into an optimization problem with constraints according to the first association relationship model; and

Step S202 of solving the optimization problem according to the multichannel non-stationary seismogram and an objective optimization method so as to obtain the elastic impedance.

It can be seen from the first association relationship model that it is an ill-posed problem, and in order to fast obtain the elastic impedance by solving, this ill-posed problem is converted into an optimization problem with constraints in the present embodiment, that is:

$$arg {min}_{{Z}_{θ}} {\vert {Z}_{θ} \vert}_{TV} , ( s . t . ) {‖ {S}_{θ} - {W}_{θ} {D}_{t} {Z}_{θ} ‖}_{F}^{2} \leq ɛ$$

where |∇Z_{θ}|_{TV}=Σᵢ\sqrt{(∇ₜZ_{θ})ᵢ²+(∇ₓZ_{θ})ᵢ²}, ∇ₜ represents a longitudinal difference operator, and ∇ₓ represents a transverse difference operator.

In an optional embodiment, as shown in FIG. 3, the objective optimization method comprises Split-Bregman iterative method, and the step S202 of solving the optimization problem according to the multichannel non-stationary seismogram and an objective optimization method so as to obtain the elastic impedance comprises step S301 and step S302, wherein:

Step S301 of determining an initialization parameter; and

Step S302 of solving the optimization problem by utilizing the Split-Bregman iterative method on the basis of the initialization parameter and the multichannel non-stationary seismogram, so as to obtain the elastic impedance.

Existing solving methods comprise the gradient method, the ADMM method (that is, alternating direction multiplier method) and the like, the Split-Bregman iterative method (an optimization method of the L1 regularization cost function) adopted in the present embodiment is subject to optimized solution and is more suitable for the TV regularization solution in the present embodiment, wherein the solving is fast and stable.

The Split-Bregman iterative method is adopted in the present embodiment for solving the above optimization problem, with the following steps:

Step 1: initializing data: number of iterations k=0, the elastic impedance of the first iteration Z_{θ}⁰=Z₀, an intermediate variable of the algorithm dₜ⁰=0, dₓ⁰=0, and an intermediate variable of the algorithm bₜ⁰=0, bₓ⁰=0, where Z₀ represents an initial value of the elastic impedance;

Step 2: initializing parameters: λ, μ, σ, tol, and maxIter, where λ, μ, and σ are all regularization parameters, tol represents an iteration stopping conditional error, and maxIter represents a maximal number of iterations;

Step 3: letting A=μ(WₐDₜ)^{T}WₐDₜ+λ(Dₜ)^{T}Dₜ, B=λDₓ(Dₓ)^{T}, where both A and B are intermediate variables;

Step 4: starting iteration: when ∥Z_{θ}^{k+1}−Z_{θ}^{k}∥>tol and k<maxIter, let C=μ(WₐDₜ)^{T} S+λ(Dₜ)^{T}(dₜ^{k}−bₜ^{k})+λ(Dₜ)^{T}(dₓ^{k}−bₓ^{k}), where C is an intermediate variable, S represents a multichannel non-stationary seismogram, dₜ⁵, bₜ^{k}, dₓ^{k}, bₓ^{k} all represent intermediate variables of the current iteration; it is known that A=UΛU^{T}, B=VΣV^{T}, \tilde{C}=U^{T}CV, that is, the matrix A undergoes singular value decomposition to obtain U and Λ, and the matrix B undergoes singular value decomposition to obtain V and Σ. The element

$${\tilde{z}}_{ij} = \frac{{\tilde{c}}_{ij}}{{λ}_{i} + {σ}_{i}}$$

in \tilde{Z}, λᵢ and σᵢ are respectively diagonal elements of λ and Σ;

$${Z}_{θ}^{k + 1} = U \tilde{Z} {V}^{T}$$

$${s}^{k} = \sqrt{{\vert {∇}_{t} {Z}_{θ}^{k} + {b}_{t}^{k} \vert}^{2} + {\vert {∇}_{x} {Z}_{θ}^{k} + {b}_{x}^{k} \vert}^{2}}$$

$${( {d}_{t}^{k + 1} )}_{i , j} = max ( {s}^{k} - \frac{1}{λ} , 0 ) \frac{{∇}_{t} {Z}_{θ}^{k} + {b}_{x}^{k}}{{s}^{k}}$$

$${( {d}_{x}^{k + 1} )}_{i , j} = max ( {s}^{k} - \frac{1}{λ} , 0 ) \frac{{∇}_{x} {Z}_{θ}^{k} + {b}_{x}^{k}}{{s}^{k}}$$

$${b}_{t}^{k + 1} = {b}_{t}^{k} + σ ( {∇}_{t} {Z}_{θ}^{k} - {d}_{t}^{k + 1} )$$

$${b}_{x}^{k + 1} = {b}_{x}^{k} + σ ( {∇}_{x} {Z}_{θ}^{k} - {d}_{x}^{k + 1} )$$

$$k = k + 1$$

The above steps are executed repeatedly, until a preset stop condition is satisfied.

Step 5: outputting the result Z_{θ}^{k+1} of the last iteration as the elastic impedance result.

In an optional embodiment, the step S103 of determining an elastic parameter corresponding to the elastic impedance according to an established second association relationship model comprises the following step S401 bis step S402, wherein:

Step S401 of determining an expression form of the second association relationship model. In the above, the expression form comprises a discrete matrix form; and

Step S402 of obtaining the elastic parameter through the solution by means of the least square method according to the elastic impedance and the second association relationship model in the discrete matrix form.

The above second association relationship model represents the corresponding association between the elastic impedance and the elastic parameter in a form of a discrete matrix. In order to facilitate the calculation, a formula corresponding to the above second association relationship model can be written in the discrete matrix form, that is:

$$[ \begin{matrix}log ( {EI}_{{θ}_{1}} ) \\ log ( {EI}_{{θ}_{n 2}} ) \\ ⋮ \\ log ( {EI}_{{θ}_{n}} )\end{matrix} ] = [ \begin{matrix}1 + {tan}^{2} ( {θ}_{1} ) & - 8 K {sin}^{2} ( {θ}_{1} ) & ( 1 - 4 K {sin}^{2} ( {θ}_{1} ) ) \\ 1 + {tan}^{2} ( {θ}_{2} ) & - 8 K {sin}^{2} ( {θ}_{2} ) & ( 1 - 4 K {sin}^{2} ( {θ}_{2} ) ) \\ ⋮ & ⋮ & ⋮ \\ 1 + {tan}^{2} ( {θ}_{n} ) & - 8 K {sin}^{2} ( {θ}_{2} ) & ( 1 - 4 K {sin}^{2} ( {θ}_{n} ) )\end{matrix} ] [ \begin{matrix}log ( {V}_{p} ) \\ log ( {V}_{s} ) \\ log ( ρ )\end{matrix} ]$$

In the present embodiment, the least square method can be adopted to solve this problem, and specifically, let:

$$G = [ \begin{matrix}1 + {tan}^{2} ( {θ}_{1} ) & - 8 K {sin}^{2} ( {θ}_{1} ) & ( 1 - 4 K {sin}^{2} ( {θ}_{1} ) ) \\ 1 + {tan}^{2} ( {θ}_{2} ) & - 8 K {sin}^{2} ( {θ}_{2} ) & ( 1 - 4 K {sin}^{2} ( {θ}_{2} ) ) \\ ⋮ & ⋮ & ⋮ \\ 1 + {tan}^{2} ( {θ}_{n} ) & - 8 K {sin}^{2} ( {θ}_{2} ) & ( 1 - 4 K {sin}^{2} ( {θ}_{n} ) )\end{matrix} ]$$

$$B = [ \begin{matrix}log ( {EI}_{{θ}_{1}} ) \\ log ( {EI}_{{θ}_{n 2}} ) \\ ⋮ \\ log ( {EI}_{{θ}_{n}} )\end{matrix} ]$$

$$X = [ \begin{matrix}log ( {V}_{p} ) \\ log ( {V}_{s} ) \\ log ( ρ )\end{matrix} ]$$

The solution of the least square method of the above formula is:

X=(G^{T}G+εI)⁻¹G^{T}B

After solving X, the elastic parameter can be obtained according to the formula

$$[ \begin{matrix}{V}_{p} \\ {V}_{s} \\ ρ\end{matrix} ] = exp ( X ) .$$

In the present embodiment, the elastic impedance and the elastic parameter can be obtained through fast solving on the basis of the given first association relationship model and second association relationship model, in combination with the application of the Split-Bregman iteration method and the least square method.

### Example 2

An embodiment of the present disclosure provides a device for elastic parameter inversion, which is mainly applied to execute the method for elastic parameter inversion provided in the above contents of Example 1, and the device for elastic parameter inversion provided in the embodiment of the present disclosure will be specifically introduced below.

FIG. 4 is a structural schematic view of a device for elastic parameter inversion provided in an embodiment of the present disclosure. As shown in FIG. 4, it mainly comprises: an acquisition unit 11, a first determining unit 12, and a second determining unit 13, wherein:

the acquisition unit 11 is configured to acquire a multichannel non-stationary seismogram;

the first determining unit 12 is configured to determine elastic impedance corresponding to the multichannel non-stationary seismogram according to an established first association relationship model; and

the second determining unit 13 is configured to determine an elastic parameter corresponding to the elastic impedance according to an established second association relationship model.

In the device for elastic parameter inversion provided in the embodiment of the present disclosure, a multichannel non-stationary seismogram is firstly acquired by means of the acquisition unit 11; the first determining unit 12 is then utilized to determine elastic impedance corresponding to the multichannel non-stationary seismogram according to an established first association relationship model; and the second determining unit 13 is finally utilized to determine an elastic parameter corresponding to the elastic impedance according to an established second association relationship model. In the embodiment of the present disclosure, on the basis of the two association relationship models, the elastic impedance can be determined according to the multichannel non-stationary seismogram, and the elastic parameter can be determined accordingly, which is suitable for elastic impedance inversion and elastic parameter inversion of multichannel non-stationary seismograms.

Optionally, the first determining unit 12 includes a conversion module and a first solving module, wherein:

the conversion module converts the ill-posed problem of solving the elastic impedance into an optimization problem with constraints according to the first association relationship model; and

the first solving module solves the optimization problem according to the multichannel non-stationary seismogram and an objective optimization method so as to obtain the elastic impedance.

Optionally, the first solving module includes a determining submodule and a solving submodule, wherein:

the determining submodule is configured to determine an initialization parameter; and

the solving submodule is configured to solve the optimization problem by utilizing the Split-Bregman iterative method on the basis of the initialization parameter and the multichannel non-stationary seismogram, so as to obtain the elastic impedance.

Optionally, the second determining unit includes a determining module and a second solving module, wherein:

the determining module is configured to determine an expression form of the second association relationship model, wherein the expression form comprises a discrete matrix form; and

the second solving module is configured to obtain the elastic parameter through the solution by means of the least square method according to the elastic impedance and the second association relationship model in the discrete matrix form, wherein the second association relationship model represents the corresponding association between the elastic impedance and the elastic parameter in a form of a discrete matrix.

Optionally, the multichannel non-stationary seismogram is a collection of convolutions of multichannel non-stationary seismic wavelets under different incidence angles and stratum reflection coefficients.

Optionally, the elastic parameter comprises one or more of the following parameters: P-wave velocity, S-wave velocity, and density.

It could be clearly understandable for a person skilled in the art that for convenient and concise description, as for specific work processes of the device and the units described above, reference can be made to corresponding processes in the preceding method embodiments, and no repetitive description will be made here.

In an optional embodiment, the present embodiment further provides an electronic apparatus, comprising a memory and a processor, wherein the memory stores computer programs runnable in the processor, wherein steps of the method in the above method embodiments are implemented, when the processor executes the computer programs.

In an optional embodiment, the present embodiment further provides a computer-readable medium having nonvolatile program codes which could be executed by a processor, wherein the program codes enable the processor to execute the method in the above method embodiments.

In the description of the present embodiment, it shall be clarified that orientations or position relationships indicated by terms such as “central”, “upper”, and “lower” are orientations or position relationships shown on the basis of the drawings, merely for the purpose of facilitating the description of the present disclosure and for simplifying the description, rather than indicating or implying that a specified system or element must have a specific orientation and be constructed and operated in a certain orientation, and therefore such terms cannot be construed as limiting the present embodiment. In addition, terms such as “first” and “second” are used merely for description, and cannot be construed as indicating or implying to have importance in relativity.

In several examples provided in the embodiment, it shall be understood that the disclosed method and device can be implemented in other ways. The device embodiments described above are merely schematic, for example, the unit division refers to merely a division of logical functions, and during practical implementation, it may be divided in other ways; for another example, a plurality of units or assemblies may be combined or integrated into another system, or some features may be ignored or may not be implemented.

If the function is implemented in a form of a software functional unit and is sold or used as an independent product, the function can be stored in a nonvolatile computer-readable storage medium which could be executed by a processor. On the basis of such understanding, the technical solution of the present embodiment essentially or a part contributive to the prior art, or a part of this technical solution can be embodied in a form of a software product, and the computer software product is stored in a storage medium, including several instructions to enable computer equipment (which may be a personal computer, a server, or network equipment or the like) to execute all or partial steps of the method according to respective embodiments of the present disclosure. Moreover, the preceding storage medium includes various media being capable of storing program codes, such as USB flash disk, mobile hard disk, Read-Only Memory (ROM), Random Access Memory (RAM), magnetic disk or optical disk.

At last, it is to be clarified that the above embodiments are merely specific examples of the present disclosure, and are used to explain the technical solutions of the present disclosure, rather than limiting the same, thus, the scope of protection of the present disclosure is not limited thereto. Although the present disclosure is explained in detail referring to the preceding embodiments, it should be understood for a person ordinarily skilled in the art that any technical person familiar with the present technical field can still make modifications or readily think of variations to the technical solutions recorded in the preceding embodiments, or substitute a part of the technical features with equivalent, within the technical scope disclosed in the present disclosure. However, these modifications, variations, or substitutions do not make the essence of the respective technical solutions depart from the spirit and scope of the technical solutions of the embodiments of the present disclosure, and shall all be covered by the scope of protection of the present disclosure.

1. A method for elastic parameter inversion, comprising steps of:
acquiring a multichannel non-stationary seismogram;
determining elastic impedance corresponding to the multichannel non-stationary seismogram according to an established first association relationship model; and
determining an elastic parameter corresponding to the elastic impedance according to an established second association relationship model, wherein the first association relationship model and the second association relationship model constitute a multichannel non-stationary seismic model.

2. The method according to claim 1, wherein the step of determining elastic impedance corresponding to the multichannel non-stationary seismogram according to an established first association relationship model comprises steps of:
converting an ill-posed problem of solving the elastic impedance into an optimization problem with constraints, according to the first association relationship model; and
solving the optimization problem according to the multichannel non-stationary seismogram and an objective optimization method, to obtain the elastic impedance.

3. The method according to claim 2, wherein the objective optimization method comprises a Split Bregman iterative method, and the step of solving the optimization problem according to the multichannel non-stationary seismogram and an objective optimization method to obtain the elastic impedance comprises:
determining an initialization parameter; and
solving the optimization problem by utilizing the Split Bregman iterative method based on the initialization parameter and the multichannel non-stationary seismogram, to obtain the elastic impedance.

4. The method according to claim 1, wherein the step of determining an elastic parameter corresponding to the elastic impedance according to an established second association relationship model comprises:
determining an expression form of the second association relationship model, wherein the expression form comprises a discrete matrix form; and
obtaining the elastic parameter through solution by utilizing a least square method according to the elastic impedance and the second association relationship model in the discrete matrix form, wherein the second association relationship model represents corresponding association, in a form of a discrete matrix, between the elastic impedance and the elastic parameter.

5. The method according to claim 1, wherein the multichannel non-stationary seismogram is a collection of convolutions of non-stationary seismic wavelets under different incidence angles and stratum reflection coefficients.

6. The method according to claim 1, wherein the elastic parameter comprises one or more of following parameters: P-wave velocity, S-wave velocity, and density.

7. A device for elastic parameter inversion, comprising:
an acquisition unit, configured to acquire a multichannel non-stationary seismogram;
a first determining unit, configured to determine elastic impedance corresponding to the multichannel non-stationary seismogram according to an established first association relationship model; and
a second determining unit, configured to determine an elastic parameter corresponding to the elastic impedance according to an established second association relationship model, wherein the first association relationship model and the second association relationship model constitute a multichannel non-stationary seismic model.

8. The device according to claim 7, wherein the first determining unit comprises:
a conversion module, configured to convert an ill-posed problem of solving the elastic impedance into an optimization problem with constraints according to the first association relationship model; and
a first solving module, configured to solve the optimization problem according to the multichannel non-stationary seismogram and an objective optimization method to obtain the elastic impedance.

9. An electronic apparatus, comprising a memory and a processor, wherein the memory stores computer programs runnable in the processor, and the processor is configured to implement the method according to claim 1 when executing the computer programs.

10. The electronic apparatus according to claim 9, wherein the step of determining elastic impedance corresponding to the multichannel non-stationary seismogram according to an established first association relationship model comprises steps of:
converting an ill-posed problem of solving the elastic impedance into an optimization problem with constraints, according to the first association relationship model; and
solving the optimization problem according to the multichannel non-stationary seismogram and an objective optimization method, to obtain the elastic impedance.

11. The electronic apparatus according to claim 10, wherein the objective optimization method comprises a Split Bregman iterative method, and the step of solving the optimization problem according to the multichannel non-stationary seismogram and an objective optimization method to obtain the elastic impedance comprises:
determining an initialization parameter; and
solving the optimization problem by utilizing the Split Bregman iterative method based on the initialization parameter and the multichannel non-stationary seismogram, to obtain the elastic impedance.

12. The method according to claim 9, wherein the step of determining an elastic parameter corresponding to the elastic impedance according to an established second association relationship model comprises:
determining an expression form of the second association relationship model, wherein the expression form comprises a discrete matrix form; and
obtaining the elastic parameter through solution by utilizing a least square method according to the elastic impedance and the second association relationship model in the discrete matrix form, wherein the second association relationship model represents corresponding association, in a form of a discrete matrix, between the elastic impedance and the elastic parameter.

13. The electronic apparatus according to claim 9, wherein the multichannel non-stationary seismogram is a collection of convolutions of non-stationary seismic wavelets under different incidence angles and stratum reflection coefficients.

14. The electronic apparatus according to claim 9, wherein the elastic parameter comprises one or more of following parameters: P-wave velocity, S-wave velocity, and density.
